(19) United States
(12) Patent Application Publication
(10) Pub. No.: US 2023/0014242 A1
(43) Pub. Date: Jan. 19, 2023

(54) METHODS AND APPARATUS FOR HINDRANCE OF ADVERSE AND DETRIMENTAL DIGITAL CONTENT IN COMPUTER NETWORKS

(71) Applicant: Confiant Inc, New York, NY (US)

(72) Inventors: Jerome Dangu, Teaneck, NJ (US); Louis-David Mangin, New York, NY (US)

(21) Appl. No.: 17/900,835

(22) Filed: Aug. 31, 2022

Related U.S. Application Data
(63) Continuation of application No. 15/867,504, filed on Jan. 10, 2018.
(60) Provisional application No. 62/444,634, filed on Jan. 10, 2017.

(51) Int. Cl. H04L 9/40; H04L 67/025; G06F 21/12

(52) U.S. Cl. CPC H04L 63/145; H04L 67/025; G06F 21/128

(57) ABSTRACT

A network computer system provides logic to cause a client compute device to perform operations in connection with the client compute device rendering a publisher's webpage. The operations performed by the client compute device include retrieving rules from a collection of rules, each rule of the collection being associated with at least one of a plurality of third-party digital content identifiers, each third-party digital content identifier uniquely identifying a corresponding third-party digital content; detection of execution of a third-party tag on the client compute device, including identifying a digital content identifier that is utilized in execution of the third-party tag; matching the digital content identifier of the executing third-party tag to one of the retrieved rules; and implementing a security or compliance operation with respect to the third-party tag based at least in part on the matched rule.

### CROSS-REFERENCE TO RELATED APPLICATION(S)

This application is a continuation of U.S. patent application Ser. No. 15/867,504, filed Jan. 10, 2018 and titled “METHODS AND APPARATUS FOR HINDRANCE OF ADVERSE AND DETRIMENTAL DIGITAL CONTENT IN COMPUTER NETWORKS”; which claims priority to and benefit of U.S. Provisional Application Ser. No. 62/444,634, filed Jan. 10, 2017 and titled “METHODS AND APPARATUS FOR HINDRANCE OF ADVERSE AND DETRIMENTAL DIGITAL CONTENT IN COMPUTER NETWORKS;” both of the aforementioned priority applications being hereby incorporated by reference for all purposes.

### TECHNICAL FIELD

The present disclosure relates generally to regulation of media content obtainable over computer networks, and more particularly to the classification and regulation of adverse and detrimental digital content.

### BACKGROUND

Third-party content serving is the process of determining which content goes in which available sections on a publisher's webpage or app and then delivering the content to a user requesting a webpage or launching an app. Third-party content is not explicitly requested by a user and thus, a user has little to no control over the type of content that will be delivered upon requesting the webpage or launching the app. Moreover, third-party content can be configured to track users' behavior, obtain users personal data, load malware on a user device, and/or initiate unsecure communication sessions between user computer device and a third-party server.

### BRIEF DESCRIPTION OF THE DRAWINGS

FIG. 1 is a schematic diagram with an example of a computer network operatively coupled to a classification and hindrance server for the analysis and preemption of adverse or detrimental third-party digital content server, according to an embodiment.

FIG. 2 is a schematic block diagram illustrating a processor implementing a digital content blocking engine, a digital content analyzer engine, and publisher's third-party content manager server engine; memories and a network communication interface of a compute device for classification and hindrance of adverse or detrimental digital content, according to an embodiment.

FIG. 3 is a flow chart of an example process for classification and hindrance of adverse digital content, according to an embodiment.

FIG. 4 is a swim lane diagram illustrating a first example of digital content blocking engine and digital content risk analyzer engine, according to an embodiment.

FIG. 5 is a swim lane diagram illustrating a second example of digital content blocking engine and digital content risk analyzer engine, according to an embodiment.

FIG. 6 is a flowchart illustrating configuration of a blocking-enabled tag for third-party digital content, according to an embodiment.

FIG. 7 is a cross entity diagram illustrating processes executed by a browser scripting agent operationally coupled to a browser sandbox, according to an embodiment.

FIGS. 8A-8B are flowcharts illustrating a first example of a method for blocking adverse or detrimental third-party content, according to an embodiment.

FIGS. 9A-9B are flowcharts illustrating a second example of a method for blocking adverse or detrimental third-party content, according to an embodiment.

FIGS. 10A-10B are flowcharts illustrating a third example of a method for blocking adverse or detrimental third-party content, according to an embodiment.

FIG. 11 is a flow chart illustrating scheduled update tasks perform over a rule database containing third-party content tags and client platform profiles for the hindrance of adverse or detrimental digital content, according to an embodiment.

FIG. 12 is a flowchart illustrating an example of a method for blocking adverse or detrimental third-party content via a mutation observer, according to an embodiment.

FIG. 13 is a flowchart illustrating an example of a method for the collection of data indicative of adverse or detrimental digital content via a browser's localStorage.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. It, however, will be clear and apparent that the subject technology is not limited to the specific details set forth herein and may be practiced without these specific details. In some instances, well-known structures and components are shown in block diagram form to avoid obscuring the concepts of the subject technology.

The terms “computer”, “processor”, “computer processor”, “compute device” or the like should be expansively construed to cover any kind of electronic device with data processing capabilities including, by way of non-limiting example, a digital signal processor (DSP), a microcontroller, a field programmable gate array (FPGA), an application specific integrated circuit (ASIC), or any other electronic computing device comprising one or more processors of any kind, or any combination thereof.

As used herein, the phrase “for example,” “such as”, “for instance” and variants thereof describe non-limiting embodiments of the presently disclosed subject matter. Reference in the specification to “one case”, “some cases”, “other cases”, or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

Until now, classification and analysis of third-party digital content has been limited to issue detection and manual remediation. Manual remediation limits users and publishers to opt between completely turning off third-party content tags or exposing users to potentially unsafe or non-compliant third-party content. Often, third-party content tags are daisy chained such that, third-party content is served to users' devices from multiple servers and/or domains unbeknown to users before they load a page, click a web link and/or load an app, increasing the complexity and uncertainty of classification and analysis of third-party digital content before is loaded on their devices.

Thus, a need exists for methods and apparatus for classification of digital content and hindrance of adverse and detrimental digital content distributed over computer networks.

The subject technology is related to methods and apparatus for classification of digital content and hindrance of adverse and detrimental digital content distributed over computer networks. In some implementations, wrapping tags or blocking-enabled tags are configured with scripting language in which variables and/or processor executable functions are defined to regulate digital content distributed over computer networks. Differently stated, blocking-enabled tags are configured with processor executable and/or interpretable instructions to preempt the execution of unsolicited digital content classified as adverse or detrimental. The blocking-enabled tags are generated based on attributes of client compute devices and compliance rules implemented as computer executable instructions. In some instances, compliance rules can be generated through telemetry processes, extraction of attributes from unsolicited digital content tags, and/or emulation of user interactions with unsolicited digital content configured to be embedded in digital content or digital-based services requested by client compute devices. In some instances, the blocking-enabled tags can be maintained and updated over time through scheduled emulation and telemetry tasks.

Advantageously, the subject technology provides systems and methods to classify and preempt the loading of adverse and/or detrimental third-party digital content in near real-time or corresponding to round-trip time between two compute devices (e.g., by way of non-limiting example, on a millisecond order, such as between 25 ms and 200 ms, between 50 ms and 150 ms, between 75 ms and 125 ms, etc.). Thus, users perceive the responsiveness of the computer-based methods as immediate and as a part of a mechanical action (e.g., as part of requesting a webpage via a browser or loading an app) made by a user. It is to be understood that where a range of values is provided, such as above, each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure. Where a list of values is provided, it is understood that ranges between any two values in the list are also contemplated as additional embodiments encompassed within the scope of the disclosure, and it is understood that each intervening value to the tenth of the unit of the lower limit unless the context clearly dictates otherwise, between the upper and lower limit of said range and any other listed or intervening value in said range is encompassed within the disclosure; that the upper and lower limits of said sub-ranges can independently be included in the sub-ranges is also encompassed within the disclosure, subject to any specifically excluded limit.

The subject technology provides objective, accurate, and consistent classification of third-party content and thus, can preempt the execution of adverse or detrimental digital content. The classification and preemption of adverse and/or detrimental digital content is reliable; that is, digital content deemed to be adverse and/or detrimental is preempted to be loaded or displayed across compute devices irrespectively of whether they are mobile devices, stationary devices, and/or whether the content is called from a webpage and/or an app. The subject technology operates in near real-time and thus, optimizes security and user experience by decreasing overhead associated with human-based classification and/or intervention after adverse and/or detrimental digital content is loaded or displayed on a compute device.

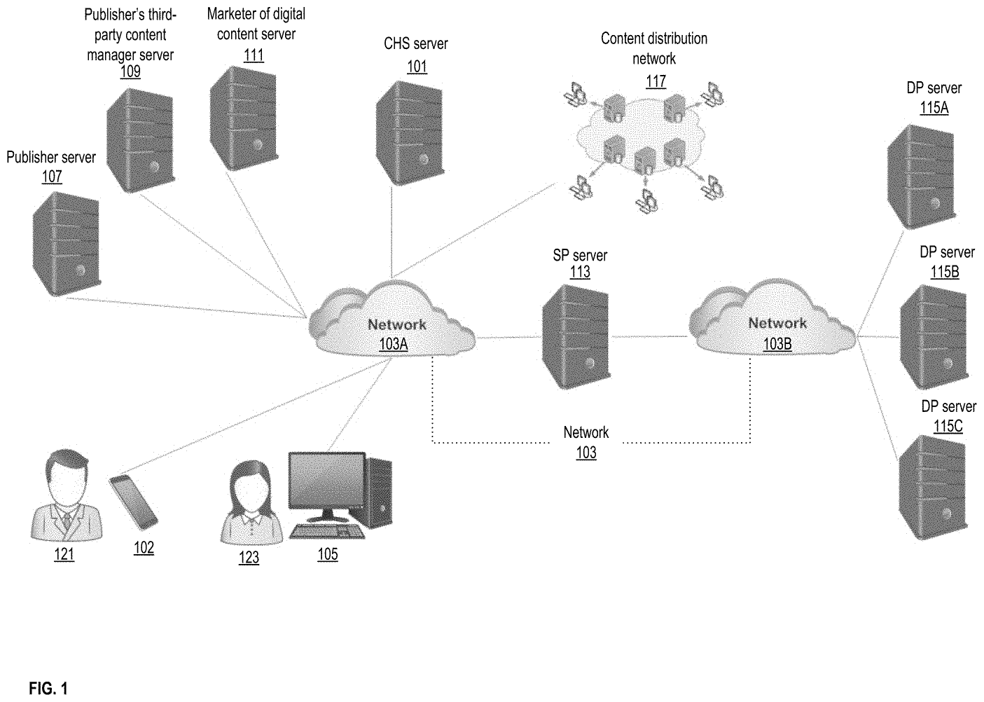

FIG. 1 is a schematic diagram with an example of a computer network with an operating classification and hindrance of digital content server, according to an embodiment. Classification and Hindrance Server (hereinafter CHS) 101 categorizes and regulates third-party digital content delivered by third-party digital content providers. The example shown in FIG. 1 includes computer network 103 represented as network 103A and network 103B. Network 103 facilitates communications across multiple compute devices including mobile compute device 102; compute device 105; publisher server 107; publisher's third-party content manager server 109; marketer of digital content server 111; CHS server 101; supply platform (SP) server 113; demand platform (DP) servers 115A, 115B, and 115C; content distribution network 117, and other compute devices not shown in FIG. 1. Networks, servers, and compute devices shown in FIG. 1 are examples of compute devices that can, at different instances and/or embodiments, establish communication and exchange data with CHS server 101; thus are not intended to suggest any limitation as to the scope of use and/or functionality of the presently disclosed subject matter.

Network 103 can include one or more types of communication networks. For example communication networks can include, the Internet, a local area network (LAN), a wide area network (WAN), a metropolitan area network (MAN), various types of telephone networks (including, for example, Public Switch Telephone Network (PSTN) with Digital Subscriber Line (DSL) technology) or mobile networks (including for example Global System Mobile (GSM) communication, General Packet Radio Service (GPRS), Code Division Multiple Access (CDMA), and other suitable mobile network technologies), or any combination thereof. Communication within network 103 can be established through any suitable connection (including wired or wireless) and communication technology or standard (wireless fidelity (WiFi®), 4G, long-term evolution (LTE™), or other suitable standard). Client compute devices 102 and 105 include one or more computer processors and computer memories, configured to perform various data processing operations.

Client compute devices 102 and 105 also include a network communication interface (not shown in FIG. 1) to connect to one or more servers via network 103. Examples of devices represented by compute device 105 include a personal computer, portable computer, dedicated server compute devices, and/or other suitable compute devices. Examples of devices represented by mobile compute device 102 include smartphones, tablets, notepads, wearable compute devices, and other suitable types of mobile compute devices. As described in further detail herein, in some instances, compute devices 102 and 105 can be connected to network 103 via an intranet; an Internet Service Provider (ISP) and the Internet; a cellular network; and/or other suitable network communication system.

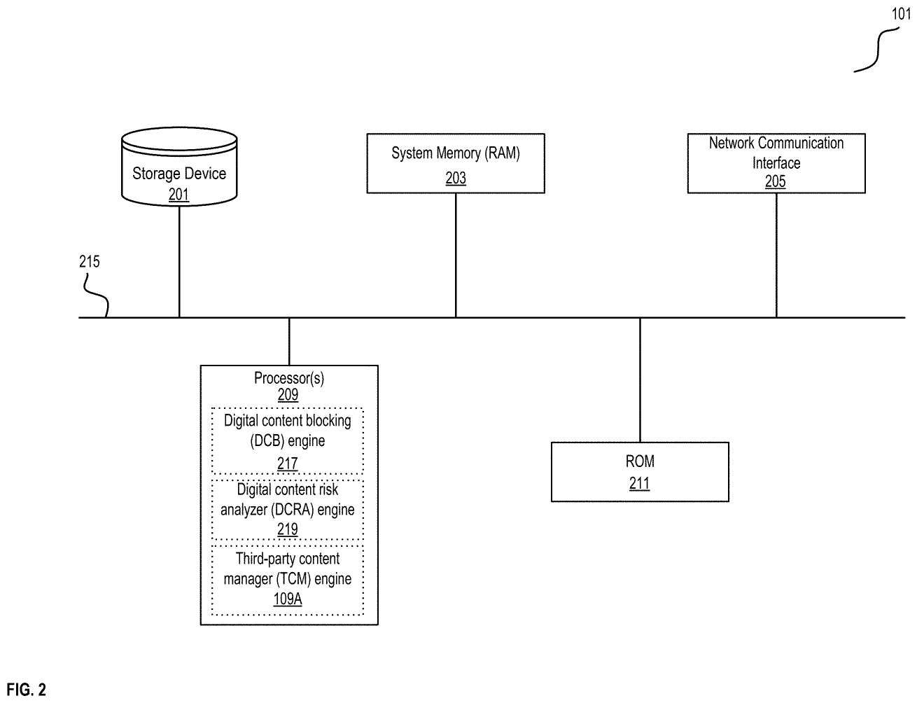

CHS server 101 includes one or more computer processors and computer memories, configured to perform multiple data processing and communication operations associated with classification of digital content provided by third-party entities and for hindrance of adverse and detrimental digital content distributed over computer networks. In general, CHS server 101 analyzes digital content generated by third-party servers, executes one or more risk analysis processes, classifies third-party digital content, and depending on classification outcomes, determines whether or not, client compute devices should retrieve third-party digital content. In some implementations, CHS server 101, or one or more processes executed by CHS server 101 can be implemented in publisher server 107, publisher's third-party content manager server 109, and/or other compute device. Further structural and functional components of an embodiments of CHS server 101 are discussed below with reference to FIG. 2.

Publisher server 107 includes one or more computer processors and computer memories, configured to perform multiple data processing and communication operations associated with the delivery of publisher digital content and/or services for the consumption of users 121, 123, and other suitable users. Publisher digital content and/or services include, for example, webpages, mobile apps, Software as a Service (SaaS), and other suitable services and digital content. In some instances, publisher digital content and/or services include processor executable instructions to request third-party digital content from another server, for instance, digital content requested to one or more of servers in content distribution network 117, digital content from DP servers 115A, 115B, 115C and other suitable server connected to network 103. Such executable instructions can be carried out by client compute devices upon reception of publisher digital content and/or services provided by publisher server 107. In some implementations, publisher server 107 relies on services provided by CHS server 101 for the identification and regulation of third-party digital content configured to be delivered to client compute devices requesting publisher digital content and/or services from publisher server 107.

Publisher's third-party content manager server 109 includes one or more computer processors and computer memories, configured to deliver third-party digital content to client compute devices. Publisher's third-party content manager server 109 facilitates the placement of third-party content and delivers this content to, for example, web sites or services provided by publisher server 107. In some implementations, publisher's third-party content manager server tracks third-party content displayed to users, number of clicks made by users to the third-party content, and other suitable metrics or quota that can then be processed for statistical reports and/or analytics. In some implementations, publisher third-party content manager server 109 relies on services provided by CHS server 101 for the identification and regulation of third-party digital content configured to be delivered to client compute devices requesting publisher digital content and/or services from publisher server 107.

In some instances, publisher's third-party content manager server 109 can be implemented in a compute device separate from publisher server 109 managed by a company, person, or non-person entity providing services to publisher server 107. In some other instances, publisher's third-party content manager server and publisher's third-party content manager server 109 can be managed by a same person or same non-person entity. In yet some further instances, third-party content server 109 can be implemented and maintained in publisher server 107 as shown in an example of an embodiment provided with reference to FIG. 2.

Content distribution network (CDN) 117 is a network system connecting multiple compute devices and/or servers. CDN 117 is a large, geographically distributed network of specialized servers and/or compute devices that accelerate the delivery of third-party digital content, rich media files and other suitable content to client compute devices. In some instances, third-party digital content sent from CDN 117 is received by client compute devices upon a request for publisher digital content and/or services provided by publisher server 107. In some other instances, however, third-party digital content can be delivered to client compute devices by DP servers 115A, 115B, and 115C, SP server 113, or other suitable server shown or not shown in FIG. 1.

In some instances, a salient difference between digital content and/or services provided by publisher server 107 and third-party digital content is that the former is explicitly requested by users (e.g., user 121 and user 123) while the third-party digital content is embedded in publisher digital content and/or services according to, for example, user's demographic characteristics, behavioral characteristics, and/or other suitable user-centric characteristics (e.g., user compliance profile). In some instances, third-party digital content embedded in publisher digital content and/or services is often selected to be delivered to users based on outcomes from realtime bidding (RTB) processes where multiple bids are exchanged between DP servers to earn a digital slot or space within publishers' digital content and/or service.

Marketer of digital content server 111 includes one or more computer processors and computer memories, configured to promote or announce third-party digital content on behalf of, for example, third-party users and/or non-person entities wanting to gain publicity or reach users for purposes unsolicited by users. Supply platform server 113 includes one or more computer processors and computer memories, configured to perform operations on behalf of publisher server 107. Specifically, supply platform server 113 manages sections within publisher digital content and/or services provided by publisher server 107 that can be configure to embed third-party digital content. Each of the demand platform servers 115A, 115B, and 115B includes one or more computer processors and computer memories, configured to perform operations on behalf of third-party publisher servers, for example, third-party publisher server 109 and other suitable types of third-party publisher servers. Specifically, demand platform servers 115A, 115B, and 115C submit bids to SP server 113 to win digital slots or spaces for the inclusion of third-party digital content in sections embedded in publisher digital content and/or services provided by publisher server 107, or other suitable publisher server.

Any of users 121 and 123 can request publisher digital content and/or services provided by publisher server 107. For example, user 121 can launch an app on mobile device 102 to start a client session with publisher server 107 and then retrieve publisher digital content and/or services. For another example, user 123 can enter a Uniform Resource Locator (URL) to a browser installed in compute device 105 to retrieve publisher digital content and/or services. The aforementioned request methods are some examples of how users can request content and/or services provided by publisher server 107. These methods can be interchangeably used depending on applications, data, users' preferences, services, and other suitable user dependent and compute devices dependent factors. Alternatively or additionally, other methods to initiate communication sessions and/or gain connectivity from client compute devices to publisher server 107 can be similarly employed. Thus, the examples of methods to request content or services from publisher server 107 are not intended to suggest any limitation as to the scope of use and/or functionality of the presently disclosed subject matter.

In some instances, digital content and/or services provided by publishers include embedded tags designated to include third-party digital content. In some instances, these tags can be configured to trigger and execute calls to SP server 113, passing along, for example, information about available spaces or digital slots for the inclusion of third-party digital content and the identity of publisher server 107. Accordingly, in some instances, SP server 113 can retrieve one or more cookies or other suitable data files associated with client compute devices (e.g., mobile compute device 103 and compute device 105) and/or users. Thereafter, SP server 113 can request bids from DP servers 115A, 115B and 115C. SP server 113 sends the cookie or other suitable data files retrieved, for example, from client compute devices to each of the DP servers. DP servers executes one or more processes to value the offer to embed third-party content within publisher digital content and/or services provided by publisher server 107.

In general, the richer the data available about users, the higher the bids from DP servers would be. In some instances, several DP servers place bids and send redirecting links to SP server 113 configured to call marketer of digital content server 111, servers in content distribution network 117, a winning DP server, and/or other suitable servers. Such redirecting links are used in case their bids end up being selected by SP server 113. SP server 113 selects a winning bid, and sends the link received from the winner DP server to publisher server 107 which calls CHS server 101 to classify and/or preempt adverse or detrimental third-party digital content from being served to users' compute devices. In some instances, the winner DP server can send the redirecting link directly to publisher server 107. In some other instances, such a redirect link can be sent to publisher server 107 by other suitable server.

FIG. 2 is a schematic block diagram illustrating a processor implementing a digital content blocking engine, a digital content analyzer engine, and publisher's third-party content manager server engine; memories and a network communication interface of a compute device for classification and hindrance of adverse and detrimental digital content, according to an embodiment. In some implementations, CHS server 101 can be a compute device, such as a hardware platform server configured to support mobile applications, Software as a Service (SaaS) applications, a web site, and/or other suitable applications accessible to client compute device 105 and/or mobile compute device 102 in FIG. 1.

Bus 215 collectively represents system, peripheral, and/or chipset buses that communicatively connect numerous internal devices of CHS server 101. For instance, bus 215 communicatively couples processor 209 with read-only memory 211, system memory (RAM) 203, storage device 201, and network communication interface 205. From these various memory units, processor 209 can retrieve instructions to execute and/or data to perform processes for classification, and hindrance of adverse and detrimental digital content. In some implementations, processor 209 can be a single processor, a multi-core processor, a master-slave processor arrangement or other suitable compute processing device. In some implementations, processor 209 can be any suitable processor such as, for example, a general purpose processor, a field programmable gate array (FPGA), an application specific integrated circuit (ASIC), and/or other suitable hardware device.

CHS server 101 can further include physical compute devices not shown in FIG. 2 e.g., a database server, a third-party content manager server, and/or other suitable server deployed in a cloud computing network environment. A cloud computing network environment enables ubiquitous, convenient, on-demand network access to a shared pool of configurable compute resources (e.g., networks, servers, storage, applications, and services) that can be rapidly provisioned via, for instance, virtualization and released with minimal management effort or service provider interaction, and then scaled accordingly. A cloud model can implement numerous functions (e.g., on demand self-service, broad network access, resource pooling, rapid elasticity, and measured service), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Thus, in some implementations CHS server 101 and other suitable servers shown in FIG. 1 can be implemented in a cloud-based environment.

In some implementations, CHS server 101 can include any combination of one or more computer-usable or computer-readable media. For example, CHS server 101 can contain or can be operatively coupled to computer-readable medium including system memory or random access memory (RAM) device 203, a read-only memory (ROM) device 211, a magnetic storage device 201 and other suitable memory devices. In some implementations, CHS server 101 can include a general purpose processor and/or on one or more specialized processors configured to execute and optimize the processing tasks performed by Digital Content Blocking (DCB) engine 217, Digital Content Risk Analyzer (DCRA) engine 219, Third-party Content Manager (TCM) engine 109A, and other processes implemented and executed by processor 207.

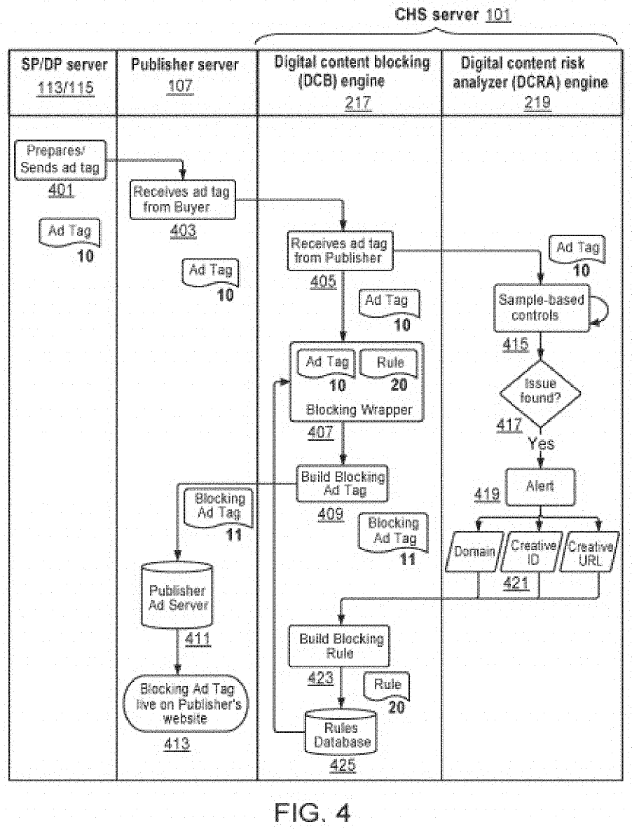

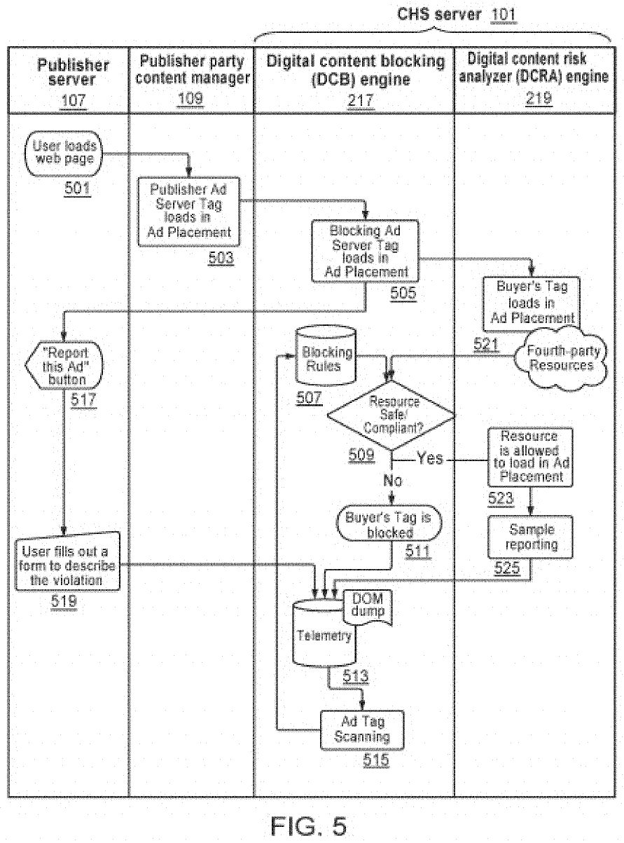

In some implementations, storage device 201 can be physically integrated to CHS server 101; in other implementations, however, storage device 201 can be a repository such as a Network-Attached Storage (NAS) device, an array of hard-disks, a storage server or other suitable repository separated from CHS server 101. In some instances, storage device 201 includes data structures and/or databases utilized by DCB engine 217, DCRA engine 219, TCM engine 109A, and other suitable engines and/or processes executed by processor 209. For example, in some implementations storage device 201, stores third-party content tags, third-party content server identifiers, third-party content domain names, and other data associated with third-party content recognizable by CHS server 101. For another example, storage device 201 stores white lists of domain names, third-party content servers, and third-party content tags, allowed to be served along with digital content provided by one or more publishers. Such white lists can be configured or customized according to publishers policies based, for example, on a set of non-compliant parameters and/or rules to regulate deliverance of adverse and detrimental third-party digital content. In some instances, blocking-enabled tags generated by CHS server 101 can block a given third-party content on behalf of some publishers while the same third-party content may not be blocked for other publishers, depending on each publisher policies. Storage device 201 can also include one or more instances of databases and/or data structures including rules database 425, blocking rules database 507, telemetry database 513, discussed with reference to FIG. 4 and FIG. 5 of this specification.

In some instances, DCB engine 217, DCRA engine 219, and third-party content manager engine 109A are implemented as hardware, software, and/or a combination of hardware and software. For example, storage device 201 (or other suitable memory coupled to processor 209 or CHS server 101) can include processor-executable instructions and/or data to configure processor 209 to execute tasks performed by engines 217, 219, and 109A. Accordingly, in some instances, processor 209 can retrieve processor executable instructions and data to execute multiple CHS processes from one or more of the memory devices shown in FIG. 2.

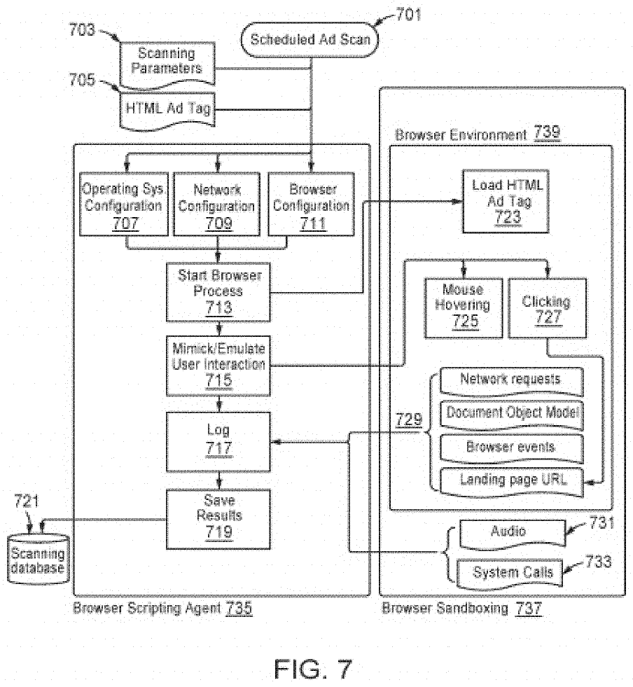

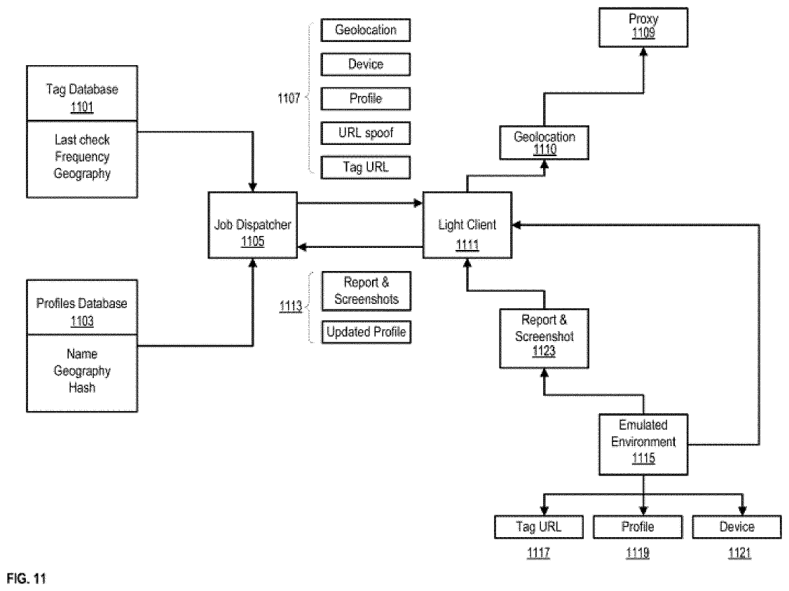

In general, DCB engine 217 generates blocking-enabled tags associated with third-party content. DCB engine includes a blocking rule database with rules to determine whether or not a blocking-enabled tag should be configured to block third-party content. Rules stored in a blocking rule database are derived from multiple processes, including policies associated with a publisher server, e.g., publisher server 107 discussed with reference FIG. 7, outcomes and/or insights provided by DCRA engine 219, and/or telemetry-based data, discussed with reference to FIG. 11. Telemetry processes are implemented to collect measurements and other suitable data associated with third-party content and third-party content servers, such measurements and data are stored at a telemetry database implemented by DCB engine 217. Further details, regarding functional and structural attributes of DCB engine 217 are discussed throughout this specification, for example, with reference to FIG. 4 and FIG. 5.

In general, DCRA engine 219 analyzes third-party content tags and/or third-party content to determine whether or not adverse and/or detrimental digital content is associated with a third-party content tag. For example, in some instances DCRA engine 219 implements scanning processes that emulates sample based controls such as hovering, and clicking on a third-party content to determine whether such emulated events result on unsecure communications with third-party content servers, load of malicious third-party content, and/or cause other adverse or detrimental effects on client compute devices or publisher servers. In some instances, a third-party content tag can be daisy chained to other third-party content tags, thus redirects calls to multiple third-party content servers can result upon a first third-party content tag is loaded or called at a client compute device. In such a case, daisy chained third-party content tags are identified and further analyzed to determine potential adverse or detrimental effects. Further details regarding functional and structural attributes of DCB engine 217 are discussed throughout this specification, for example, with reference to FIG. 4 and FIG. 5.

In some implementations, TCM engine 109A, is hosted by CHS server 101. TCM engine 109A is functionally analogous to publisher third-party content manager server 109 discussed with reference to FIG. 1. Accordingly, TCM engine 109A tracks third-party content displayed to users, number of clicks made by users to the third-party content, and other suitable metrics processed to produce statistical reports and/or analytics. In some implementations, TCM engine 109A relies on services provided by DCB engine 217 and DCRA engine 219 for the identification and regulation of third-party digital content configured to be delivered to client compute devices.

Bus 215 can also couple CHS server 101 to network 103 shown in FIG. 1 through network communication interface 205. Network communication interface 205 can include one or more wireless transceivers for performing wireless communication and/or one or more communication ports for performing wired communication. In some implementations, network communication interface 205 can be configured to communicate with publisher server 107, client compute devices 102 and 105, and other suitable compute devices shown in FIG. 1. Thus, CHS server 101 can be part of a network of computers (for example a local area network (“LAN”), a wide area network (“WAN”), or an Intranet, or a network of networks, for example, the Internet.

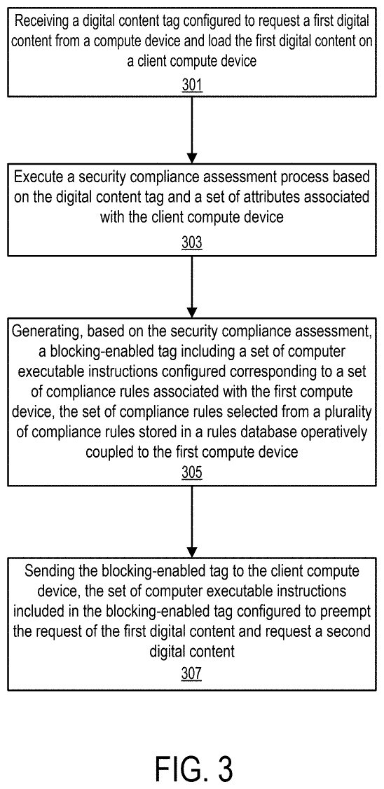

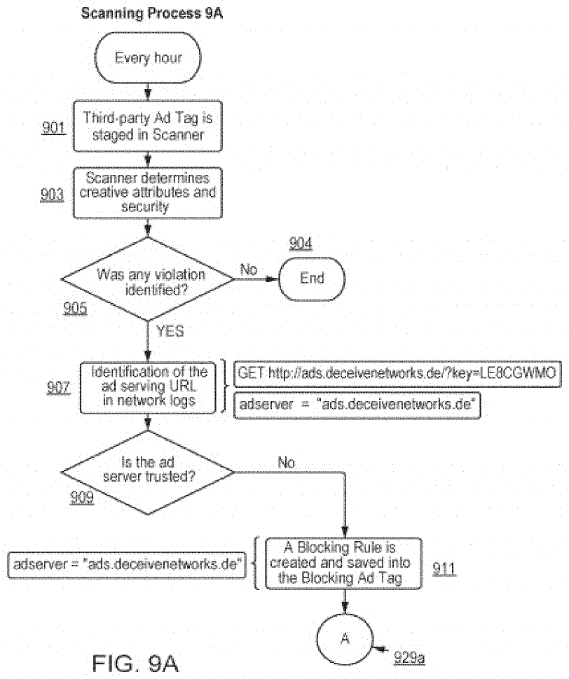

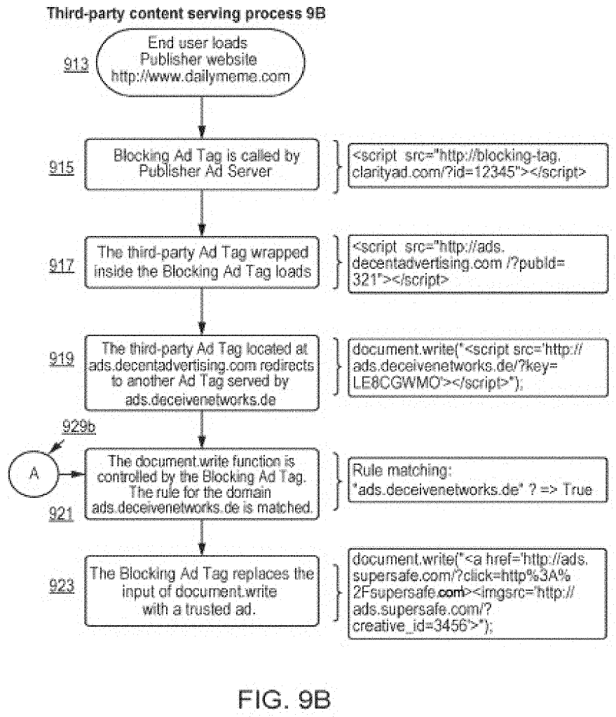

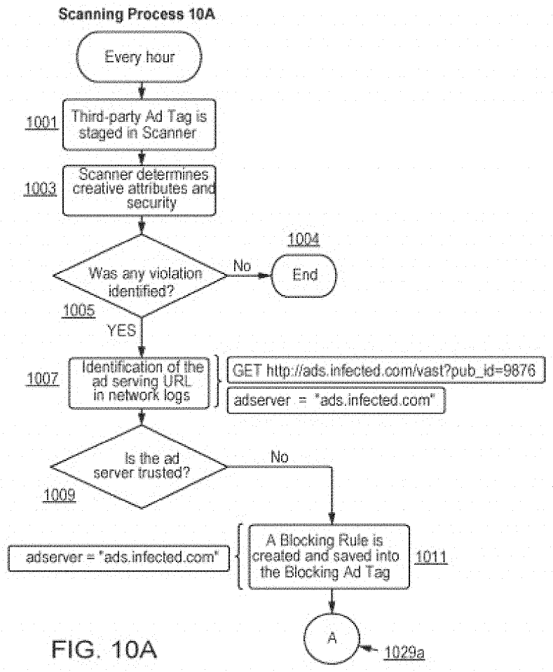

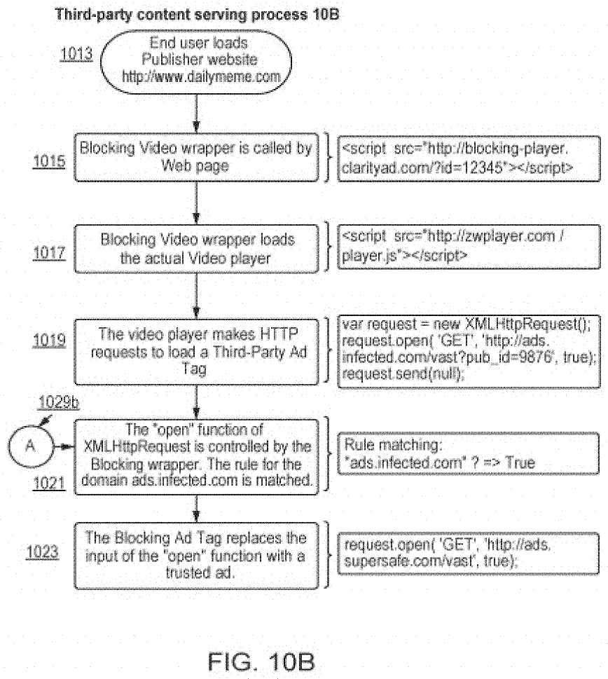

FIG. 3 is a flow chart of an example process for classification and hindrance of adverse digital content, according to an embodiment. In some implementations, CHS server 101 receives at 301 a digital content tag configured to request a third-party digital content from a second compute device, (for example, a third-party digital content server included in content distribution network 117 discussed with reference to FIG. 1) and configured to load the third-party digital content on a client compute device, for example, client compute device 102 or 105 discussed with reference to FIG. 1. Thereafter, CHS server 101 executes at 303 a security compliance assessment process based on the digital content tag and a set of attributes associated with the client compute device. Further details with respect to security compliance assessment process are further discussed with reference to, for example, in FIG. 4 at 417, FIG. 5 at 509, FIG. 9A at 905, and FIG. 10A at 1005.

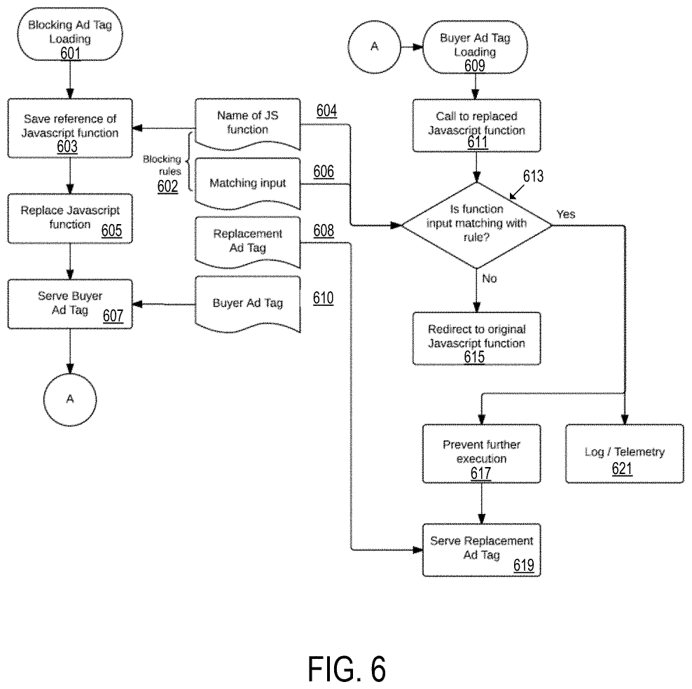

The CHS server 101 generates, based on the security compliance assessment, a blocking-enabled tag including a set of computer executable instructions corresponding to a set of blocking rules and/or compliance rules associated with publisher server 107. The set of computer executable instructions is further discussed with reference to, for example, FIG. 6 at 605. The set of blocking rules and/or compliance rules selected from a plurality of compliance rules stored in a rules database operatively coupled to the CHS server 101. In some instances, the rules database is implemented and stored in storage device 201 discussed with reference to FIG. 2. The CHS server 101 can send the blocking-enabled tag to the client compute device. The set of computer executable instructions included in the blocking-enabled tag can be configured to preempt the request of the third-party digital content and request a second digital content.

Many of the examples discussed below are discussed in the context of third-party content associated with advertising campaigns. The contexts in which the subject technology is discussed are not intended to suggest limitations as to the scope of use and/or functionality of the presently disclosed subject matter. For example, the subject technology can be analogously used in non-advertising context in which client compute devices require high levels of cyber security and avoidance of intrusive and unsolicited third-party digital content.

FIG. 4 is a swim lane diagram illustrating an example of a process for classification and/or hindrance of adverse digital content, according to an embodiment. Publisher server 107 receives and forwards selected third-party content tag 10 (also referred to herein and labeled in FIG. 4 as “Ad Tag 10”), at 403, to CHS server 101. Selected third-party content tag 10 includes, for example, Hypertext Markup Language (HTML) associated with selected third-party content server, targeting information such as targeted geographical area, types of targeted compute devices, targeted audience profiles, and other suitable targeting information. In some instances, targeting information is used to execute digital content processes and/or digital content risk analysis as discussed below.

In some instances, DCB engine 217, wraps, at 407, selected third-party content tag 10 into a blocking-enabled tag according to a set of rules executed during digital content risk analysis process. Accordingly, a set of HTML instructions or other suitable markup or script language of selected third-party content tag 10 is stored as an encoded JavaScript string such that blocking-enabled tag built at 409 is eventually served to client compute devices such that, client compute devices retrieve secure and/or pre-approved third-party content.

In some implementations, JavaScript functions such as document.write can be used to act as a regular intermediary in a daisy chain of third-party content tags however, other suitable scripting and non-scripting functions can be interchangeably used. For instance, third-party content tags can be configured to be daisy-chained, such that, a first third-party content tag associated with a first third-party digital content provider includes a redirect call to a second third-party content tag associated with a second third-party content provider, and so on. Third-party digital content resulting from daisy chained configurations can be nondeterministic. Thus, in some examples, the DCB engine 217 effectively manages nondeterministic redirect calls by wrapping the outermost tag in a daisy chained configuration into a blocking-enabled tag (e.g., 407). In this instance, blocking-enabled tag 407 remains persistent throughout the daisy chained configuration ensuring secure redirect calls and/or pre-approved third-party content.

JavaScript code of blocking-enabled tag 11 includes encoded third-party content tag, blocking JavaScript code, and processor executable instructions corresponding to blocking rules associated with blocking-enabled tag 11 (also referred to herein and labeled in FIG. 5 as “Blocking Ad Tag 11”). Blocking-enabled tag 11 can be formatted as a public URL which is sent to publisher server 107 emulating a format of a conventional third-party content tag (e.g., JavaScript, Iframe, and other suitable technology). Accordingly, in some examples, the blocking-enabled tag 11 can be functionally similar to selected third-party content tag 10 but with encoded blocking capabilities. In some instances, blocking-enabled tags are built with an empty rule set until an issue is found via scanning, visitor reporting, telemetry, or other suitable security method discussed throughout the disclosed subject technology.

As discussed above, in some implementations, publisher's third-party content manager server 109 (shown in FIG. 1) can be implemented in publisher server 107 as a TCM engine 109A (shown in FIG. 2). Accordingly, publisher server 107 sets up and/or configures TCM engine 109A, at 411, such that, TCM engine includes blocking-enabled tag 11, upon client compute device request for publisher digital content and/or services. Thus, blocking-enabled tag 11 is sent and executed along publisher digital content and/or services provided by publisher server 107. Stated differently, blocking-enabled tag 11 goes “live” with digital content and/or services provided by publisher server 107 as shown at 413.

In some instances, when selected third-party content tag 10 is received by CHS server 101 from publisher server 109, DCRA engine 219 executes a scanning process (also referred herein as security compliance assessment) to classify the third-party digital content. DCRA engine 219 can reside on a separate system or as part of CHS server 101 and performs sample-based controls, at 415 on selected third-party content tag 10 by replicating or emulating various browser environments (as shown, for example, in FIG. 7). Scanning parameters applied to selected third-party content tag 10 can be received as part of step 405 from the publisher server or preconfigured in DCRA engine 219.

In some instances, issues are detected during the scanning process at 417, because, for example, selected third-party content tag 10 shows malicious actions, adverse behavior, impermissible user tracking (e.g., browser fingerprinting), or violated publisher's ad policies, comprehensive information about the state of selected third-party content tag 10 as loaded is extracted and retained. Such extracted and retained information includes state of Document Object Model (DOM), Uniform Resource Locator (URL) of ad creative (if any), URL of the landing page (if any), URL of the “creative tag”, which is the last tag nested in the daisy-chain of third-party content tags when multiple third-party content providers are involved in the selected third-party content tag. When an issue is detected via scanning, a probability level, score, or other suitable ordinal, or discrete value is calculated to indicate a measure of risk to which users are exposed to.

The DOM is generated by a browser whenever a web page is loaded. The DOM is a programmatic representation of the web page that allows code in a scripting language, for example, JavaScript to convert static content into something more dynamic. For example, scripting code can be programed to modify the DOM representation by adding new div elements. A div element can define a new section in a web page and inside this new section a virtual object (VO) data structure representing third-party content can be added to the DOM through, for example, a document.write Application Programming Interface(API) call for the insertion of a VO representing a given third-party content. Thus, programmed scripting language can modify the DOM representation and therefore, the content and/or sub-content rendered on client compute devices can be controlled.

In some instances, when DCRA engine 219 detects an issue, at 417, associated with third-party content tag during scanning process, the DCRA engine 219 identifies third-party digital content responsible for the detected issue and can issue an alert at 419, such that a blocking rule can be built that uniquely targets adverse third-party digital content. Accordingly, in examples, data of the alert and third-party digital content are sent to DCB engine 217, at 421, such data includes, for example, in the case of a malicious digital advertisement, a domain name, a creative identification, a creative URL and other suitable data. Accordingly, DCB engine 217 generates a blocking rule, at 423, for the issue found, additionally or alternatively DCB engine 217 sends a confirmation request to publisher server 109 prior to executing the rule, such that, publisher server 107 notifies and prevents, when needed, third-party content that will be configured to be blocked. A blocking rule includes an “input” value holding a fragment of HTML (or other suitable markup language) that uniquely identifies third-party digital content configured to be blocked. Some examples of such fragments include: Creative ID in GET function parameters of third-party content tags; URL of third-party content assets (or a fragment of it); name and/or identifier of the domain generating the issue (whether because a call to the domain serves nonsecure content, because the served content is known to be malicious, because the domain is known to be malicious, because the domain and/or content is banned by publisher server 107 for any reason non-related to security or other suitable constraints). These types of fragments are inferred from data points identified during the scanning process or during serving of third-party digital content, for example, via a network log with initiator information.

In some instances, fragments included in a given rule can include each HTTP response containing third-party active content configured in, for example, JavaScript, HTML, plugin objects like Adobe Flash, and other suitable third-party active content. Third-party active content can include an initiator URL, corresponding to a third-party content tag redirecting to another third-party content tag, forming a daisy chain from a selected third-party content tag all the way down to a third-party content tag associated with an ultimate (or last) buyer of digital space offered by a publisher of digital content and/or digital service provider.

In some other instances, a digital content identifier can include an ad creative ID and/or creative URL, or other suitable field. An ad creative is a digital object associated with a format that contains data to render an ad or other digital content at a client device. Ad creatives can vary such that, digital content is configured to be displayed or rendered in various ways. For instance, an ad creative can be configured to render a banner when a web page loads; then multiple panels and/or floating ads can be launched from the banner via a cursor click, cursor hovering or auto-initiation. For another example, an ad creative can be configured to display digital content on a transparent layer over a web page. For yet another example, an ad creative can be configured to display video content based on interactive functionality via an interactive layer rendered over video content such that different video segments are delivered in response to user interactions.

In some instances, DP servers such as, DP server 115A, 115B, and 115C (shown in FIG. 1) can serve creatives and do not have the capability to redirect to other third-party content tags however, such DP servers can produce “creative tags”. A URL associated with a creative tag carries information uniquely tied to the creative or third-party digital content and as such, can be used as the source of a blocking rule. This information bears different names depending on the served third-party digital content referred to herein as “creative ID.” In the absence of a recognizable creative ID, the creative URL is obtained by inspecting the DOM for graphical assets. The creative URL is a unique identifier and that can be associated with a blocking rule. In yet some other instances, fragments can include JavaScript traces. For example, each third-party content server in a third-party content tag chain can rely on JavaScript to either redirect to the next third-party content server in the chain or to serve a creative tag. This process typically relies on JavaScript functions such as document.write. In although other functions may be used instead. Thus, JavaScript traces include called functions and outputs produced during third-party digital content chain.

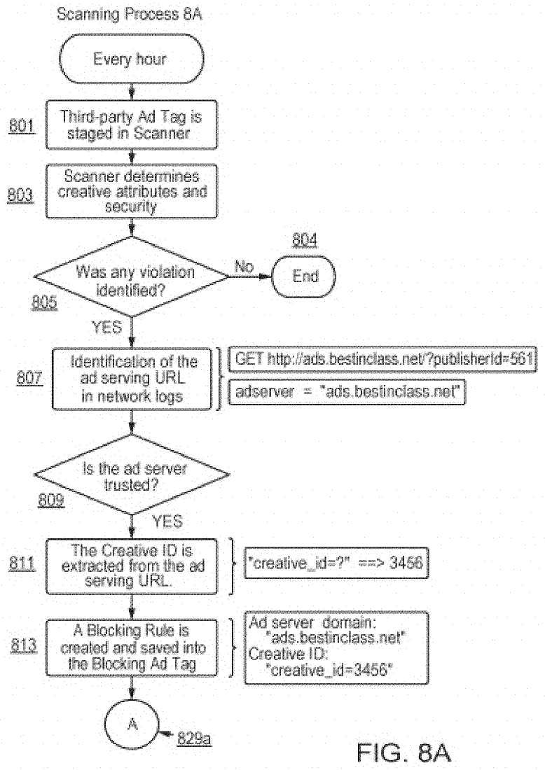

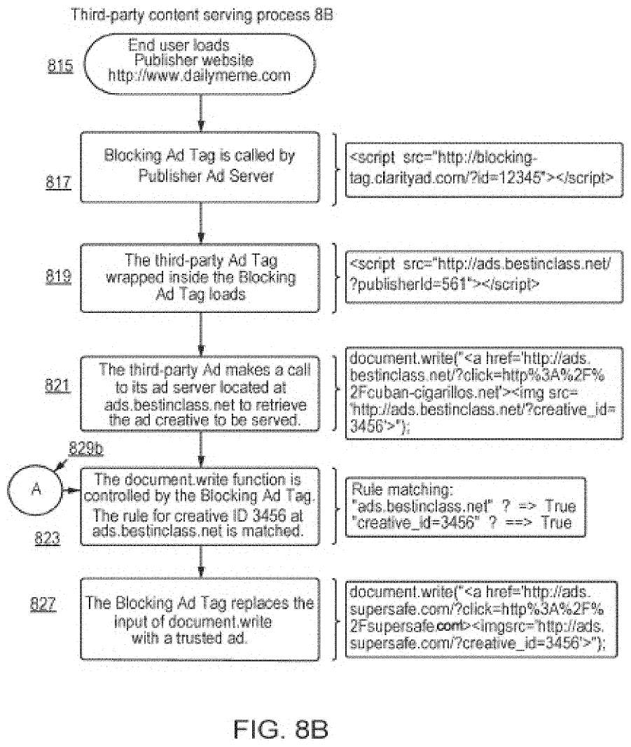

In some implementations, DCRA engine 219 logs calls (also referred herein as network logs) to script functions to keep track of the functions used during a serving of a third-party content chain and their respective input parameters. This log then informs the rule generation process about which script functions require to be patched to filter out creatives where issues were found. In some examples, the blocking rule generation process at 423 can be executed differently depending on whether a domain associated with third-party content is determined to be adverse (i.e., shows an issue at 417) or whether it is trusted/known or not. In some cases when a third-party content server is classified as trusted, a predictable way to obtain creative IDs can be used to parse URLs in the network logs using, for example, regular expressions or sub-string matching. Creative IDs can then be used as input for rules as discussed, with reference to FIGS. 8A-8B. Rules are optimized to let trusted third-party content servers run creatives that have not been flagged as having a compliance or security issue. In some implementations, when it is determined that a given third-party content server serves acceptable or non-adverse third-party content most of the time, such a third-party content server can be classified as trusted because, blocking all the traffic from such third-party content server would have an unnecessary disruptive impact on the campaign's deliverability and performance.

In some implementations, when a third-party content server is classified as untrusted/unknown, the domain included in its associated third-party content tag or the creative URL is used as the input for a rule, as discussed with reference to FIGS. 9A-9B. DCB engine 217 produces rule(s) 20 at 423 and stores such rule(s) in rules database 425. Each time the DCB engine 217 produces a new rule at 423, blocking-enabled tags such as blocking ad tag 11 are logically related to the new rule, and such a new rule is integrated to a set of rules stored in rules database 425.

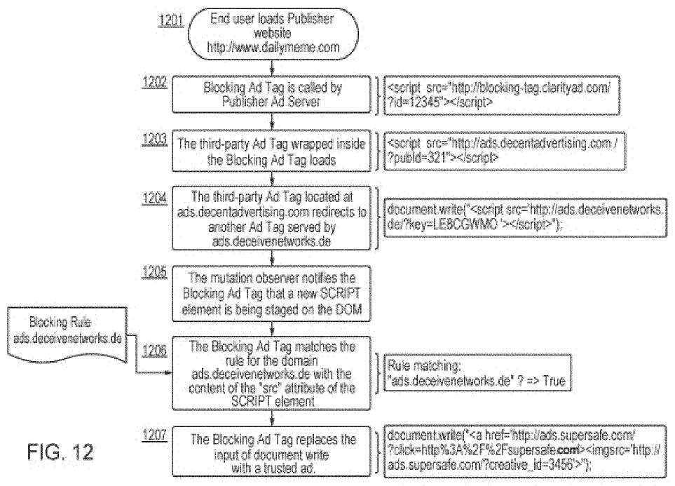

In some implementations, a mutation observer is leveraged as an alternative to patching relevant ad serving functions like document.write, to achieve a similar instrumentation. As the browser adds any active element to the DOM (such as SCRIPT, IFRAME and others), the mutation observer notifies the DCB engine 217 so that the content of such a DOM element can be matched with blocking rules. In case a match occurs, the DCB removes the matched element from the DOM, which effectively prevents further execution. An example of a process to serve third-party content using a mutation observer is discussed below with reference to FIG. 12.

FIG. 5 is a swim lane diagram illustrating a second example of digital content blocking engine and digital content risk analyzer engine, according to an embodiment. In some instances, when a client compute device loads publisher digital content, for example, a webpage, a signal indicating a request is received at 501 by publisher server 107. An analogous process is performed when publisher server 107 receives a signal from a client compute device indicating that a client compute device has launched an app hosted by publisher server 107.

In some instances when a browser installed on a client compute device loads a webpage, publisher third-party content manager server 109 configures scripts, at 503, for the display of third-party content embedded in the requested webpage. Such scripts are controlled by publisher third-party content manager server 109 to determine whether third-party content should be delivered to a client device or not. Because the publisher server 107 has fulfilled preparatory steps to replace a third-party content tag received by, for example, SP server 113 or a DP server, with a blocking-enabled tag (as described with reference to FIG. 4), the blocking-enabled tag is served by publisher third-party content manager server 109 instead of the third-party content tag as shown at 505. Accordingly, the blocking-enabled tag loads the third-party content tag and in some instances, the third-party content tag loads fourth-party dependencies including potentially harmful active content, for example, JavaScript, iframes, plugin objects including Adobe Flash objects and other suitable digital content as shown at 521. The term “fourth party,” as used herein, refers to an entity that has a direct or indirect relationship with third-party content provider, DP service providers, SP service provider, or other suitable entities, who request loading their own content tags on the publisher's page.

The blocking-enabled tag gets loaded with blocking rules maintained in the CHS server 101, specifically rules contained in blocking rules database 507. These blocking rules are obtained via scanning processes, inputs, reports received from users, and/or telemetry as further explained below.

Using instrumentation of a JavaScript API as predetermined in the blocking rules, blocking-enabled tags intercept calls relevant to JavaScript APIs to match their inputs with values predetermined in by blocking rules 507, thus assessing safety and compliance of digital content at 509. If a match is found, the instrumented JavaScript API function does not run. Accordingly, the execution of the third-party content tag and any other content tag daisy chained from such third-party content tag is not executed or blocked at 511.

In some instances, when a third-party content tag and/or any other content tag daisy chained from such a third-party content tag fails the safety and compliance assessment at 509, DCR engine 219 replaces the unsafe or noncompliant tag with a trusted third-party content tag and/or pass-back the third-party content tag to DCRA engine 219 as shown at 523. The Document Object Model (DOM) output of the third-party content tag is serialized and submitted to the DCB engine 217 for telemetry/logging purposes at 513. Telemetry data is submitted to the ad-scanning functionality for verification. If no match is found, the third-party content tag JavaScript calls are allowed to proceed normally and any associated resources load as usual at step 523.

In some instances, third-party content associated with advertising campaigns may be served following an auction for ad placement in webpage hosted at a publisher server. Multiple third-parties electronically bid for the placement of their ad. In these auctions, the content of the highest bid (by dollar amount) is selected to be executed. When such content tag and/or any other content tag daisy chained from such a third-party content tag fails the security and compliance assessment at 509, DCR engine 219 replaces the unsafe or noncompliant tag with a tag from the second highest bidder in auction. The DCR engine 219 can, for example, query a database associated or implementing the auction to retrieve a tag paired to the second highest bidder and use such a tag as replacement for the winner tag (i.e., the tag associated with the highest bidder) in case the winner tag fails the security and compliance assessment.

On a sample basis, telemetry is submitted at 525 to DCB engine 217 to maximize the scope of third-party content being scanned. For example, DCRA engine 219 may not be set-up to scan from a specific geography whereas telemetry is received from all geographies where actual visitors are located. If no match is found and the content is allowed to load, a “Report this content link is added, (for example, a link to report an unwanted ad content 517), underneath the content, to invite visitors to voluntarily report any quality issue or violation in the loaded content. At 519, publisher server 109 receives a message including a form filled out by a user describing an issue associated with third-party content and declarative information, a DOM dump of the third-party content is retrieved and submitted, at 513, to telemetry database via DCB engine 217 for telemetry/logging purposes. At 515, a third-party content tag scanning process identifies issues that feed into rules database 501.

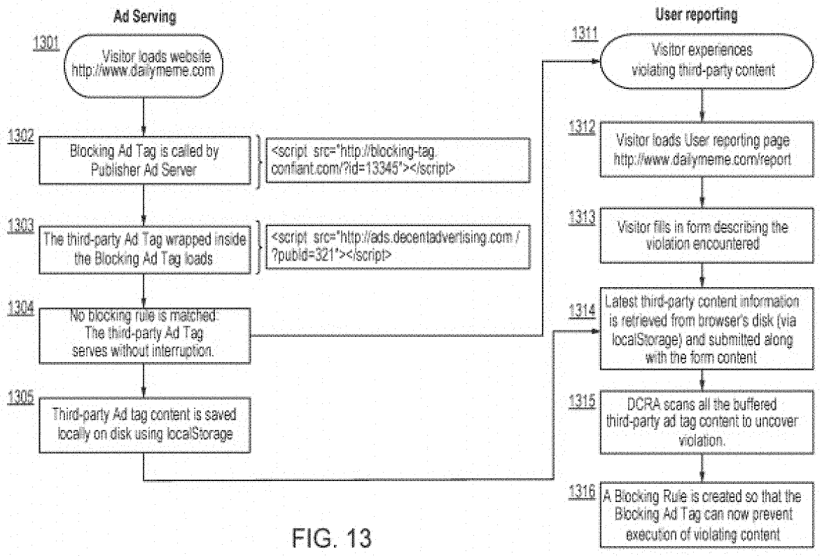

In some instances, the DCB engine 217 preemptively collects information on any content for which no match is found and that is allowed to execute. Such information may include the content itself (snippets of HTML or other suitable markup or script language), URLs of third-party hosted resources, any ID identifying the third-party serving the content, etc. A buffer of most recent third-party content information is maintained in the browser in localStorage. Websites can include processor executable instructions to store content on the browser's disk via localStorage to be retrieved at a later time. In case the user experiences an issue and submits a form at 519 to describe the violation, the content of the localStorage is retrieved from disk and submitted along the message to feed into the telemetry for scanning 515. An example of a process for the collection of adverse or detrimental content via localStorage is discussed below with reference to FIG. 13.

FIG. 6 is a flowchart illustrating an example of rule-based method, according to an embodiment. In some instances, digital content blocking engine 217 builds blocking-enabled tags as described in FIG. 4 during the third-party trafficking process. When the blocking-enabled tag loads at 601, it stages the controlled execution flow. In some implementations, blocking-enabled tag 601 contains blocking rules including: 1) a JavaScript function 604 to intercept, and 2) an input 606 to match against all calls to this function. In some instances, these rules are obtained from the scanning process (see FIG. 5). Blocking-enabled tag 601 contains a third-party content tag 610 as well as an optional verified replacement content tag 608 in case the third-party content tag is blocked. In step 603, for each rule to be applied, the JavaScript code of the blocking-enabled tag saves a reference to the JavaScript function and replaces it at 605 with a filtering proxy function. This replacement allows the blocking-enabled tag 601 to control the execution flow based on information collected during scanning. Once this is done for all functions to be replaced, the blocking-enabled tag serves and loads the third-party content tag as illustrated at steps 607 and 609.

In some instances, during the execution of third-party content tag it can be determined whether the third-party content tag is configured to make calls to the JavaScript function that has now been replaced. When the third-party content tag calls such a JavaScript function, for example at step 611, a filtering proxy function is called instead. In step 613, the filtering proxy function starts by inspecting its caller arguments, comparing them against the input corresponding to third-party content configured to be blocked. This comparison can be based on sub-string matching or regular expressions. If there is no match, the function calls the original function with the caller's arguments unchanged as shown at 615 and returns the resulting value to the caller. In such a case, the third-party content is deemed safe and/or acceptable, and the execution flow is not altered.

In some instances, digital content blocking engine 217 maximizes its performance by the implementation of rule matching processes at multiple string levels or substrings, such that, a single rule can be configured to match more than one input. For example, a rule defined as rule_1=[“adserv1.com”,“?creative=”, “123”] would match more than one input value, including, input1=“<script src=′http://www.adserv1.com/adserving?creative=123′>” and any other inputs containing the substrings “adserv1.com” and “?creative=”, “123” (e.g., input2=“<script src=′http://www.adserv1.com/contentserving?creative=123′>”). In some implementations, a set of rules can be instantiated in a tree data structure having an arbitrary depth. Nodes in a tree can represent substrings included in a rule. In such a case, each tree branch defined from root node to leaf node specifies a rule. An input and a rule are considered to match when, for example, each node in a tree branch is sequentially matched from root node to leaf node. The rule-input matching process can be performed by traversing the tree structure using a depth first search, a breadth first search, or other suitable traversal algorithm.

In some instances when there is a match at 613, the function does not proxy to the original JavaScript function, and further execution is prevented as shown at 617. Since the third-party content tag is dependent upon successful execution of this function, the ad serving is interrupted.

Optionally or alternatively, the blocking-enabled tag may serve a verified replacement content tag 608 as shown at 619. Such a verified replacement content tag can be, for example, an advertisement tag, including pass-backs—such that the publisher third-party content manager server 109 dynamically defines which ad to serve as a replacement for the blocked third-party content. Moreover, when it is determined that there is a match during step 613, the information is also submitted to publisher third-party content manager server 109 for telemetry/logging purposes as shown at 621.

FIG. 7 is a cross entity diagram illustrating processes executed by a browser scripting agent operationally coupled to a browser sandbox, according to another embodiment. In some instances, a scanning job is initiated on a scheduled time or on demand as shown at 701. Scanning parameters 703 are predetermined based on information passed by the publisher server 107 and provided to the CHS server 101 with the scanning functionality. Examples of scanning parameters include:
geography of a campaign indicating choice of proxy server to load the third-party content tag (so that the scanning environment's client IP matches the targeting of the third-party content tag), as well as the operating system time zone and the browser preferred language. In some instances, a campaign can be defined as a series of third-party content messages that share a single idea and theme which make up an integrated marketing communication;
client compute device dependent properties including, compute device type (e.g., mobile device such as tablet, phone, laptop, desktop or other suitable category); compute device screen resolution (e.g., dots per inch (DPI) screen definition), browser user agent, availability of browser plugins, and other client compute device dependent properties; and third-party content tag 705 obtained from publisher server 107.

In some instances, all, some, or other suitable parameters are passed to a browser scripting agent, which role is to set up an environment that matches the parameters, pilot the browser, mimic user interaction, and log results. In step 707, at the operating system level, the time zone of the system clock is defined according to the geography specified, and the browser plugins are enabled (desktop environments) or disabled (mobile/tablet environments). The browser is configured to use a proxy server that matches the required geography at 709, and to emulate the selected device (user agent, screen) at 711. The browser scripting agent 735 starts the browser process in step 713 and loads the tag into browser environment 739, as shown at 723. Once the tag is loaded, it mimics user interaction with the third-party content by generating mouse events such as mouse hovering 725, mouse clicks 727, and other suitable user interactions. This allows triggering of additional events like audio or expansion of the ad that may only happen upon user interactions with the third-party content. For example, upon a mimicked click interaction over third-party content, a webpage can be loaded at a client compute device by landing a webpage associated with a URL. Events triggered through user interactions can result in different operations at a compute device as shown at 729. These operations include network requests, changes to the DOM model, events generated by a given browser, landing a webpage and other suitable events.

The browser scripting agent generates a comprehensive log including information obtained from mimicking user interaction with third-party content at 717. Examples of information included in the produced log include:
Network requests—used to check against black lists of malicious domains and to list “creative tags,” and identify creative IDs;
Landing page URL checked against lists of unsafe/malicious URLs;
Snapshot of the Document Object Model (DOM) indicating graphic assets loaded on the third-party content from which URLs can be inferred;
List of all or a selected set of events triggered in the browser, including new window (popup), change of location URL, and other suitable events; and
JavaScript traces indicating logs of calls made to standard JavaScript API functions with their input parameters. In some instances, JavaScript traces are obtained and used for blocking rule generation purposes.

In some implementations, events such as associated audio outputs 731 and system calls 733 are obtained via sandboxing browser 737. Accordingly, interception of system calls 733 at the operating system level is performed to assess security issues by testing network calls and responses for detection of abnormal behavior resulting from, for example, software vulnerabilities exploited to achieve remote code execution. In some implementations, it is determined whether such events are automated (e.g., forcefully delivered to client compute devices) or delivered in response to user interactions and whether these events are triggered on mouse hover, on click, or other suitable user interactions with third-party content. In some instances, such determinations can be executed by matching each event to a time when a user interaction was mimicked or performed. At 719, data points obtained during the scanning process are saved or recorded in a dataset stored for the generation of blocking rules as discussed at 423 with reference to FIG. 4.

Examples of adverse third-party content hindered by blocking-enabled tags are provided below. FIGS. 8A-8B are flowcharts illustrating an example of a method for blocking third-party content, according to an embodiment. The example provided in FIG. 8 is discussed in the context of loading digital content from a website, for example dailymeme.com, however, an analogous process can be executed in cases where a publisher server hosts apps, SaaS or other suitable services.

FIG. 8A illustrates an example of a scanning process, according to an embodiment. FIG. 8B illustrates a third-party content serving process, according to another embodiment. In examples, processes such as shown by FIG. 8A and FIG. 8B may be implemented by DCRA engine 219, shown with reference to FIG. 2. Further, in examples, processes of FIG. 8A and FIG. 8B may be logically coupled by node A shown at 829A and 829B. The processes of FIG. 8A and FIG. 8B can be configured to execute iteratively at a predetermined interval of time, for example, once per hour or other suitable interval. In some implementations, third-party content tags are wrapped in block-enabled tags as discussed with reference to FIG. 4. Accordingly, such blocking-enabled tags can be configured to be scanned to identify third-party content being served to client compute devices, and assess, for example, if such third-party content violates publisher policies, or whether or not third-party content is classified as unsecure and/or adverse.

In some implementations, at each hour, a background task initiates a scanning process for each third-party tag retrieved from, for example, the domain name, dailymeme.com. Each block-enabled tag received from a call to the publisher digital content in which the domain dailymeme.com is hosted, is staged for analysis through scanner process 8A, at 801. Accordingly, at 803, attributes of the third-party digital content associated with block-enabled tags are determined. Based on the attributes determined at 803, conditional statement 805 is executed to verify whether or not, adverse third-party content or inappropriate content violates publication policies set-up at the publisher server hosting the website dailymeme.com. In some instances, when the analyzed third-party content is determined to be safe, the scanning process ends at 804. In other instances a violation to a publication policy is determined; for example, dailymeme.com can have a policy for the exclusion or censorship of tobacco content, and thus when the third-party content is identified as an ad for tobacco products, a violation to such publication policy is determined. The full network log (HTTP requests made by the third-party content tag) is parsed, at 807. The scanning process 8A can identify during the parsing process executed at 807, client requests calls (e.g., GET commands) directed to the third-party content server hosting ads.best.inclass.net.

In the provided example, during scanning process 8A it is identified that third-party content is configured to be served from a trusted third-party content server at 809, in this case third-party content server ads.bestinclass.net. A third-party content server is determined to be trusted if such a third-party content server has been previously white-listed by CHS server 101. In this case, ads.bestinclass.net is included in the CHS server white-list thus, at 811, unique identifier(s) of the third-party content are extracted from a URL associated with the third-party content, using, for example, regular expression matching; verbal expression matching defined as descriptive, chainable functions; and other suitable string pattern matching techniques. In the examples provided with FIG. 8A and FIG. 8B the extracted third-party unique identifier is shown to correspond to string 3456 however, other more complex identifiers can be similarly identified included identifiers with alphanumerical identifiers, non-alphanumerical tokens, and other suitable characters or tokens.

In some implementations, the extracted domain name and third-party unique identifiers (ads.bestinclass.net, 3456) are used, at 813, to configure a blocking or compliance rule and create a blocking-enabled tag. Such a blocking-enabled tag is activated by a client compute device associated with a user as discussed below at 823 with reference to third-party content serving process (e.g., see FIG. 8B).

In some instances, third-party content serving process (see FIG. 8B), is configured to track, at 815, when a user loads a website associated, for example, with domain name dailymeme.com on a client compute device. Such a website can be hosted at publisher server 107 discussed with reference to FIG. 1. Accordingly, a publisher third-party content manager server (e.g., server 109 in FIG. 1) calls blocking-enabled tags for the serving of third-party content at 817. Thereafter, a third-party content tag contained or wrapped inside blocking-enabled tag is loaded at 819, for example, through the execution of the script:

<script
src=“http://ads.bestinclass.net/?publisherId=561”></script>

The third-party content tag can run with JavaScript code (or code defined in other scripting or programming language) included in the blocking-enabled tag configured to control and/or regulate execution and third-party content such that, non-adverse third-party content and content according to publisher server policies is retrieved and displayed on the user client compute device. As a result, third-party content tag makes a call at 821 to, for example, an associated third-party content domain, in this case, to ads.bestinclass.net such that, third-party content can be served at the user's client compute device. In some instances, a response from a third-party content server received from the call executed at 821 can be in the form of a snippet and/or code in JavaScript. Such a response can be configured to perform calls to the DOM document.write API function to insert a VO data structure indicative of third-party content on the DOM instantiated at the client compute device for the dailymeme.com website loaded at 815. Example of an originally retrieved code is provided below:

```
    document.write( “<a href=
  ‘http://ads.bestinclass.net/?click=http%3A%2Fc uban
cigarillos.net’><img src=‘http://ads.bestinclass.net
  /?creative_id=3456’></a>”)
```

In the example provided above, an image file is a type of third-party content configured to be inserted into a webpage of dailymeme.com website and its associated DOM model. However, the subject technology is equally capable to handle other type of third-party content according to the apparatus and methods disclosed herein, additional examples of third-party content include linear media content, non-linear media content, executable in-stream content, and other suitable types of third-party content. In this case, an image is originally configured to be served to the client compute device from third-party content server urbancigarrillos.net. As part of the image insertion a document.write call is configured to be performed by the client compute device to update its current version of the DOM model corresponding to the dailymeme.com website such that, the new version reflects the insertion of the third-party content i.e., the image. Instead however, the executable code in the blocking-enabled tag takes control over the aforementioned execution flow and replaces and/or overwrites the snippet and/or JavaScript code received in the response from the third-party content server. Differently stated, the retrieved document.write is controlled by the blocking-enabled tag. Accordingly, at 823, the new or overwritten code executes a matching process for the received document.write input against blocking rules obtained, for example, during a scanning process (e.g., see FIG. 8A). More specifically, the received code and set of attributes extracted from the received code at 821 are used to determine based on rules generated at 813 whether or not, the third-party content is classified as adverse and/or is against the policies of the publisher of dailymeme.com. Examples of matching processes performed at 823 include:
Whether the domain “ads.bestinclass.net” is matched; and
Whether the unique identifier for this third-party content matches the id number “3456”.

In some instances, a full match is established. Thus, instead of calling the native document.write function with the input from ads.bestinclass.net, the blocking-enabled tag calls a document.write function with a trusted third-party content tag, provided by, for example, the publisher server hosting the dailymeme.com or other suitable trusted server, as shown at 827. Accordingly, the third-party content classified to be in violation of dailymeme's third-party content policy is not loaded to the user's client compute device.

FIGS. 9A and 9B illustrate additional example processes for blocking third-party content, according to one or more embodiments. Processes such as described by FIG. 9A and FIG. 9B are logically coupled by node A shown at 929A and 929B. The processes described with reference to FIGS. 9A-9B can be configured to execute iteratively at a predetermined intervals of time, for example, once per hour. Analogously to the example discussed with reference to FIGS. 8A-8B, third-party content tags can be wrapped in block-enabled tags as discussed with reference to FIG. 4. Accordingly, such blocking-enabled tags can be configured to be scanned to identify third-party content being served to client compute devices, and assess, for example, if such third-party content violates publisher policies, or whether or not third-party content is classified as unsecure and/or adverse.

In some implementations, at each hour, a background task initiates a scanning process for each third-party tag retrieved from, for example, the domain name, dailymeme.com. Each block-enabled tag received from a call to the publisher digital content in which the domain dailymeme.com is hosted, is staged for analysis through scanner process at 901. Accordingly, at 903, attributes of the third-party digital content associated with block-enabled tags are determined. Based on the attributes determined at 903, conditional statement 905 is executed to verify whether or not, adverse third-party content or inappropriate content violates publication policies set-up at the publisher server hosting the website dailymeme.com. Differently stated, a security compliance assessment is executed on the website. In some instances, when the analyzed third-party content is determined to be safe, the scanning process ends at 904. In other instances a violation to a publication policy is determined, for example, if the third-party content is identified as to be redirecting the control flow towards an unsecure domain or website, such as, a website or domain classified to be a fraudulent website or “scam” website. The full network log (HTTP requests made by the third-party content tag) is parsed, at 907. During such a parsing process executed at 907, a client request (e.g., a GET call) made to the third-party content server hosting ads.deceivenetworks.de is identified.

In the provided example, during the scanning process (e.g., see FIG. 9A) it is identified that third-party content is configured to be served from an untrusted third-party content server at 909, in this case third-party content server ads.deceivenetworks.de. In some implementations, a third-party content server is determined to be untrusted if such a third-party content server has not been previously white-listed by CHS server 101. In this case, ads.deceivenetworks.de is not included in CHS server 101 white-list. Thus, at 911, a blocking rule is created and included in a blocking-enabled tag configured to preempt any forcefully redirection of the control flow to the domain ads.deceivenetworks.de. Such a blocking-enabled tag is activated by a client compute device associated with a user as discussed below at 921 with reference to third-party content serving process 9B.

In some instances, the third-party content serving process (e.g., see FIG. 9B), is configured to track, at 913, when a user loads a website associated, for example, with domain name dailymeme.com on a client compute device. Such a website can be hosted at publisher server 107 discussed with reference to FIG. 1. Accordingly, at 915, publisher third-party content manager server (e.g., server 109 in FIG. 1) calls blocking-enabled tags for the serving of third-party content. Thereafter, at 919, a third-party content tag contained or wrapped inside blocking-enabled tag is loaded, for example, through the execution of the script: <script src=“http://ads.descentadvertising.com/?publd=321”></script>

The third-party content tag can run with JavaScript code (or other scripting or programming code) included in the blocking-enabled tag configured to control and/or regulate execution flow and third-party content such that, non-adverse third-party content and content according to publisher server policies is retrieved and displayed on the user client compute device. As a result, third-party content tag makes a call at 919 to, for example, it's associated third-party content domain, in this case, to ads.deceivenetworks.de such that, third-party content can be served at the user's client compute device. In some instances, a response from a third-party content server received from the call executed at 919 can be in the form of a snippet and/or code in JavaScript. Such a response can be originally configured to perform calls to the DOM document.write API function to insert a VO data structure representing third-party content on the DOM instantiated at the client compute device for the dailymeme.com website loaded at 913. Example of an originally retrieved code is provided below:

document.write( “<script src=
‘http://ads.deceivenetworks.de.net/?key=LE&CGWMo’> </script>“)

In the example provided above, a script including a call to an untrusted server hosting ads.deceivenetworks.de.net is configured to be executed over a webpage of dailymeme.com website and its associated DOM model. Specifically, document.write call is configured to be performed by the client compute device to update its current version of the DOM model corresponding to the dailymeme.com website such that the new version reflects any changes or third-party content received or caused to be received by the call to untrusted server hosting the domain ads.deceivenetworks.de.net. Instead however, the executable code in the blocking-enabled tag takes control over the aforementioned execution flow and replaces and/or overwrites the snippet and/or JavaScript code received in the response from the third-party content server. Differently stated, the retrieved document.write is controlled by the blocking-enabled tag. Accordingly, at 921, the new or overwritten code executes a matching process for the received document.write input against blocking rules obtained, for example, during the scanning process (e.g., see FIG. 9A). More specifically, blocking rules generated at 911 are used to determine whether or not, a domain is classified as an untrusted domain according to dailymeme.com policies.

In some instances, a full match is established. Thus, instead of calling the native document.write function with the input from ads.deceivenetworks.de.net, the blocking-enabled tag calls a document.write function configured to receive third-party content from a trusted domain hosted by a trusted server. Example of a code to replace responses from third-party content servers associated with untrusted domains is provided below:

document.write(
“<ahref=‘http://ads.supersafe.com/?click=http%3A%2Fsupersafe.net’>
<img src=‘http://ads.supersafe.com/?creative_id=3456’></a>”);

Accordingly, the redirect call to the server hosting the domain classified to be an untrusted domain is not made by the user's client compute device.

FIG. 10A and FIG. 10B illustrate additional example processes for blocking third-party content, according to an embodiment. Example processes such as described with FIG. 10A and FIG. 10B are logically coupled by node A shown at 1029A and 1029B. The processes described with FIG. 10A and FIG. 10B can be configured to execute iteratively at a predetermined intervals of time, for example, once per hour. Analogously to the example discussed with reference to examples of FIG. 8A, FIG. 8B, FIG. 9A and FIG. 9B, third-party content tags can be wrapped in block-enabled tags as discussed with reference to FIG. 4. Accordingly, such blocking-enabled tags can be configured to be scanned to identify third-party content being served to client compute devices, and assess, for example, if such third-party content violates publisher policies, or whether or not third-party content is classified as unsecure and/or adverse.

In some implementations, at each hour, a background task initiates a scanning process for each third-party tag retrieved from, for example, the domain name, dailymeme.com. Each block-enabled tag received from a call to the publisher digital content in which the domain dailymeme.com is hosted, is staged for analysis through scanner process at 1001. Accordingly, at 1003, attributes of the third-party digital content associated with block-enabled tags are determined. Based on the attributes determined at 1003, conditional statement 1005 is executed to verify whether or not, adverse third-party content or inappropriate content violates publication policies set-up at the publisher server hosting the website dailymeme.com. Differently stated, a security compliance assessment is executed on the website.

In some instances, when the analyzed third-party content is determined to be safe, the scanning process ends at 1004. In other instances, a violation to a publication policy is determined, for example, when third-party content is configured to identify security vulnerabilities in a browser, operating system, or other suitable software installed at a client device for the purpose of installing malware or any type of malicious software including virus software. The full network log (HTTP requests made by the third-party content tag) is parsed, at 1007. During such a parsing process, a client request (e.g., a GET call) made to the third-party content server hosting ads.infected.com is identified.

In the provided example, during the scanning process of an example of FIG. 10A, it is identified that third-party content is configured to be served from an untrusted third-party content server at 1009, in this case third-party content server ads.infected.com. In some implementations, a third-party content server is determined to be untrusted if such a third-party content server has not been previously white-listed by CHS server 101. In this case, ads.infected.com is not included in CHS server 101 white-list. Thus, at 1011, a blocking rule is created and included in a blocking-enabled tag configured to preempt loading of third-party content from ads.infected.com. Such a blocking-enabled tag is activated by a client compute device associated with a user as discussed below at 1021 with reference to third-party content serving process 10B.

In some instances, third-party content serving process of an example of FIG. 10B, is configured to track, at 1013, when a user loads a website associated, for example, with domain name dailymeme.com on a client compute device. Such a website can be hosted at publisher server 107 discussed with reference to FIG. 1. Accordingly, at 1015, publisher third-party content manager server (e.g., server 109 in FIG. 1) calls blocking-enabled tags for the serving of third-party content; in this example, a blocking-enabled video wrapper tag is called. Thereafter, at 1017, a third-party video player contained or wrapped inside blocking-enabled video wrapper tag is loaded, for example, through the execution of the script: <script src=“http://zmplayer.com.player.js”></script>

In this instance, it is identified at 1019 that third-party video player is configured to load third-party content via HTTP request, through the execution of the script:

var request = new XMLHttpRequest( );
request.open(‘GET’,‘http://ads.infected.com/vast?pub_id=9876’,true);
request.send(null);

The above code instantiates or initializes a new XMLHttpRequest( ) object associated with the variable request. The request.open is originally configured to retrieve third-party content from a server hosting ads.infected.com domain. However, at 1021, the XMLHttpRequest request.open function in this instance is controlled by the blocking-enabled video wrapper tag, and accordingly, the rule for the domain ads.infected.com is matched. Thus, the blocking-enabled video wrapper tag overwrites the request.open function, such that, third-party content is instead retrieved from a domain hosted by a trusted server, in this case, from ads.supersafe.com.

As discussed above, the examples of blocking-enabled tags discussed with reference to examples of FIG. 8A, FIG. 8B, FIG. 9A, FIG. 9B, FIG. 10A, and FIG. 10B are configured to execute rules under different scenarios resulting from calls to third-party content tags. Specifically, blocking-enabled tag in an example of FIG. 8A and FIG. 8B includes executable rules configured to be executed when is determined that a third-party content tag would request secure third-party digital content but such a secure digital content does violate compliance rules specified at publisher server 107. Blocking-enabled tag in FIGS. 9A-9B includes executable blocking rules configured to be executed when is determined that a third-party content tag would request third-party digital content from an untrusted third-party content server, for example a third-party content server with serving scam websites. blocking-enabled tag in FIGS. 10A-10B includes executable blocking rules configured to be executed when is determined that a third-party content tag would request third-party content with malware. Through analogous processes discussed above, blocking-enabled tags can include executable blocking rules configured to be executed under other adverse or detrimental scenarios including: 1) blocking third-party digital content based on graphical or image recognition of third-party digital content; 2) blocking third-party digital content based on semantic analysis of third-party digital content; 3) blocking third-party digital content based on specific use of unsafe functions on JavaScript or other suitable scripting and non-scripting language included in third-party digital content; 4) blocking third-party digital content based on a white-list of safe third-party digital content serving domains; 5) blocking third-party digital content based on a black-list of unsafe third-party digital content serving domains; 6) blocking third-party digital content based on latency measurements of retrieval of third-party digital content; and based on other suitable adverse or detrimental conditions associated with third-party digital content. For instance, a latency measurement threshold expressed in Round-trip time (RTT) can be used to compare the RTT from when a browser at a client compute device sends a request to third-party digital content server and when it receives a response from such a server. In some instances when such RTT reaches the latency measurement threshold then a blocking-enabled tag can replace the call to the original third-party content server with a call to a different third-party content server.

FIG. 11 is a flow chart illustrating scheduled updates to databases containing third-party content tags and client platform profiles for the hindrance of adverse and detrimental digital content, according to an embodiment. In some implementations, CHS server 101 executes a recurrent process to update third-party content tags by testing them over numerous profile platforms. Recurrent updates of third-party content tags and testing across different environment profiles are enabled to preserve reliability of the CHS system. For example, a third-party content tag can be changed or updated to make secure calls via a secure connection e.g., HTTPS (HTTP over SSL or HTTP Secure) instead of HTTP and other calls considered unsecure connections or a cybersecurity risks. HTTPS uses Secure Socket Layer (SSL) or Transport Layer Security (TLS) as a sublayer under regular HTTP application layering and therefore is preferred by some publishers. Accordingly, information regarding to the type of calls configured on third-party content tags can be updated by the process illustrated in FIG. 1. For another example, the third-party content retrieved from a third-party content server may change from non-compliant to compliant, for example, a third-party content displaying tobacco products may be modified to display content approved by policies of a server or publisher thus, the process illustrated in FIG. 11 allows the generation of updated blocking-enabled tags that would not preempt the display or loading of the new content when the new content is compliant with server or publisher policies.

Attributes associated with a third-party content tag in the database 1101 include, last time a third-party content tag was analyzed, how frequently such third-party content tag should be analyzed, and a geography or geolocation associated with the content tag. For instance, a third-party content tag can be configured to be displayed or loaded in a specific country e.g., the United States, or locations composed of regions and zones. Each region defines a separate geographic area and can have multiple, isolated locations.

Profile database 1103 includes attributes of platform or software installed on client compute devices including, for example, operative systems, browser types, mobile compute device operative systems, and any other suitable software platform configured to display digital content, and/or execute digital content. Profiles stored in database 1103 are used to test and update third-party content tags stored in tag database 1101.

In some implementations, job dispatcher 1105 can be implemented in the CHS server 101 as part of; for example, DCRA engine 219 or alternatively, job dispatcher 1105 can be implemented in a separate server operatively coupled to the CHS server 101. Job dispatcher 1105 configures scheduled tasks for the update of third-party content tags stored in tag database 1101 and profiles stored in profiles database 1103. In some implementations, job dispatcher can schedule a task to update a third-party content tag based on the frequency field of the third-party content tag. A profile for the scheduled task can be selected at random from a set of candidate profiles. For example, for a selected third-party content tag configured to load on a mobile device app, a random profile can be selected from a group of profiles including Android™, iOS™ or other suitable mobile operating system. Similar profiles can be selected to update third-party content tags configured to load on webpages, for example, an Internet Explorer™, Google Chrome™, Firefox™, and other suitable browsers.

Job dispatcher 1105 can then send multiple parameters at 1107 associated with a selected third-party content tag and selected profile to update selected third-party content and profile tags through emulation and telemetry executed by light client 1111. A proxy 1109 configured with a selected geolocation 1110 creates a connection ensuring accurate geolocation.

Light client 1111 emulates the loading of selected third-party content tag 1117 on an emulated environment (e.g., emulated environment 1115) configured according to the characteristics of the selected profile 1119 and a selected device 1121. A selected device can be a compute device, for example, a laptop, desktop, mobile compute device, virtualized compute device or any other suitable compute device. Report and screenshots 1123 are computed with information regarding, for example, displayed digital content, redirect calls initiated upon loading third-party content tag, whether a loaded third-party digital content is a malware or in any ways detrimental to the performance of a client device, and other suitable telemetry metrics.

Light client 1111 then sends data gathered during the emulation to job dispatcher 1105 including reports, screenshots, updates (if any) associated with the selected profiles or third-party content tag and other suitable data gathered during the emulation. Emulation information and updates to profiles and/or third-party content tags are stored in tag database 1101 and profiles database 1103. Accordingly, the effect of rules used by CHS server 101 for the generation of blocking-enabled tags remain effective and reliable over time even when third-party content changes and/or running profile environments change.

FIG. 12 is a flowchart illustrating an example of a method for blocking adverse or detrimental third-party content via a mutation observer, according to an embodiment. A mutation observer a can be implemented via a web API (e.g. as provided in World Wide Web Consortium W3C® DOM4 specification) provided by browsers for detecting changes in the DOM. A DOM can be logically related or logically represent a publisher's website via one or more data structures (e.g., a tree data structure). A mutation observer can monitor active elements of a website that result in nodes added or removed from the DOM, attribute changes made to the DOM nodes, changes made to text nodes, and other suitable changes in the DOM. These changes or mutations of the DOM are caused by active elements of a website that can change, for example, according to time conditions, according to user interactions, and/or executable instructions that process parameters that can change over time e.g., client-server session parameters. The mutation observer is thus, configured to execute functions or methods in response to observed DOM changes e.g., each time the DOM changes an asynchronous call to a function or methods can be performed such that the function or method is executed. As discussed above, a mutation observer can be used alternatively or additionally to patching ad serving function like document.write. In FIG. 12, a compute device of an end user loads a publisher website or application at 1201 for instance, the website www.dailymeme.com. Such a website can be hosted at publisher server 107 discussed with reference to FIG. 1. Accordingly, a publisher third-party content manager server (e.g., server 109 in FIG. 1) calls blocking-enabled tags for the serving of third-party digital content at 1202. The blocking-enabled tags contain or wrap inside third-party content tags, for instance third-party content tag:

<script
src=“http://ads.decentadvertising.com/?publisherId=321”></script>

In this example, at 1204, the third-party ad tag located at ads.decentavertising.com redirects or calls another third-party ad tag served by or located at ads.deceivenetworks.de, for example, via the execution of the script:

document.write
(“<script
src=‘ http://ads.deceivenetworks.com/?key=LE&CGWMO’></script>”);

At 1205, the mutation observer sends a notification signal to the CHS server 101 via executable instructions encoded in the blocking-enabled tag when a new active element (such as SCRIPT, IFRAME and others) is being added to the DOM. Thereafter, at 1206, the CHS server 101 uses parameters received via executable instructions encoded in the blocking-enabled tag to determine whether a rule exists that matches, for example, the domain ads.deceivenetworks.com stored in rules database 425 discussed with reference to FIG. 4. Differently stated, as the browser adds any active element to the DOM (such as SCRIPT, (FRAME and other suitable active elements), the mutation observer notifies the DCB engine 217 (at CHS server 101) that the content of such DOM element can be matched with blocking rules stored in rules database 425. Such an active element is logically related to at least one blocking-enabled tag. If a matching rule exists, the DCB engine 217 removes the matched element (e.g., ads.deceivenetwork.de) from the DOM via the blocking-enabled tag. For instance, by configuring the blocking-enabled tag to replace the input of the document.write, trusted content is delivered to the end user instead of untrusted content retrieved from ads.deceivenetwork.de. Thus, as shown at 1207, the original document.write instruction is replaced with:

document.write(“<ahref=‘http://ads.supersafe.com/?click=http%3A%2F%2Fs
upersafe.net’><img
src=‘http://ads.supersafe.com/?creative_id=3456’>”);

Thus, when the DCB engine 217 determines a rule match, further execution of code configured to load detrimental or adverse digital content is effectively prevented from execution via the blocking-enabled tag.

FIG. 13 is a flowchart illustrating an example of a method for the collection of data indicative of adverse or detrimental digital content via a browser's localStorage. A localStorage can be implemented via a web storage API (e.g. as provided in World Wide Web Consortium W3C® Web Storage Second Edition) to maintain a storage area for key/value pairs locally at a user compute device. A localStorage can be implemented using a web API to store data with no expiration date on a client compute device that is data entered by a user, retrieved or display to the user can be retrieved even when such a user has ended a client-server session. In some instances, the DCB engine 217 preemptively collects, via localStorage, information on any content for which no match is found and that is allowed to execute. As discussed above, such information may include the content itself (snippets of HTML or other suitable markup or script language), URLs of third-party hosted resources, any ID identifying the third-party serving the content, or other information that can serve to identify such a content. A buffer of most recent third-party content information is maintained in the browser in localStorage.

Websites can include processor executable instructions to store content on the browser's disk via localStorage to be retrieved at a later time. For instance, in FIG. 13 an end user compute device loads a website at 1301. A publisher third-party content manager server (e.g., server 109 in FIG. 1) calls blocking-enabled tag at 1302. At 1303, the third-party ad tag wrapped inside the blocking-enabled tag loads. In this example, no blocking rule is matched thus, the third-party ad tag is served to the client compute device at 1304 and the third-party ad tag content is saved locally on the disk of the client compute device via a localStorage object at 1305.

In some instances, when the user experiences an issue or violation to a publication policy resulting from the content served from the third-party ad tag server at 1311, the user can be prompted to submit a form at 1312 to describe the issue or violation. In some instances, the user can submit information regarding the experienced issue or violation to the publication policy via a form displayed at the client compute device at 1313. In addition, the latest third-party content information is retrieved at 1314 from the disk of the client compute device, via localStorage, and submitted along with the information entered by the user to the CHS server 101. Thereafter, the DCRA engine 219 scans at 1315 the received information including the third-party ad tag content to uncover a violation or issue with the third-party content. Thus, a blocking rule is produces at 1316, such that a blocking-enabled tag can prevent the execution or loading of the digital content found to be adverse, detrimental or in violation with a publication policy.

What is claimed is:

1. A method, comprising:
receiving, at a first compute device, a plurality of digital content tags, each of the plurality of digital content tags being configured to execute in client environments to load a corresponding third-party digital content;
for each digital content tag of the plurality of digital content tags, executing a security compliance assessment on the digital content tag based at least in part on a set of parameters associated with a publisher, including performing sample-based controls on the digital content tag by replicating or emulating one or more client compute environments;
wherein for at least a first digital content tag of the plurality of digital content tags, executing the security compliance assessment includes determining, for at least a first digital content tag of the plurality of digital content tags, (i) a security or compliance issue associated with the first digital content tag, and (ii) an identifier that uniquely identifies the corresponding third-party digital content of the first digital content tag that is responsible for the determined issue; and
wherein for at least the first digital content tag, the method further comprises:
generating a blocking rule to match to the identifier of the corresponding third-party digital content of the first digital content tag;
generating a blocking-enabled tag that is logically related to the blocking rule; and
providing the blocking-enabled tag to a client compute device in connection with the client compute device rendering web-based content of the publisher, the blocking-enabled tag being configured to execute on the client compute device to prevent, based on the blocking rule, the client compute device from being served the corresponding third-party digital content of the first digital content tag.

2. The method of claim 1, further comprising:
determining the identifier of the corresponding third-party digital content using network log information obtained from executing the security compliance assessment.

3. The method of claim 2, wherein the identifier is based at least in part on a fragment that uniquely identifies the corresponding third-party digital content.

4. The method of claim 3, wherein the fragment corresponds to a script or code for the corresponding third-party digital content.

5. The method of claim 3, wherein the fragment corresponds to a caller argument used with execution of the first digital content tag.

6. The method of claim 3, wherein the fragment corresponds to an HTTP response to execution of the first digital content tag.

7. The method of claim 1, wherein the blocking-enabled tag is configured to cause the client compute device to perform steps comprising: requesting a second third-party digital content in place of the corresponding third-party digital content.

8. The method of claim 1, wherein generating the blocking rule is based at least in part on a set of policies of the publisher.

9. The method of claim 1, wherein the first digital content tag includes script code.

10. The method of claim 9, wherein executing the security compliance assessment on the digital content tag includes determining information on an execution flow of the script code.

11. The method of claim 10, wherein determining the security or compliance issue is based on analyzing the information produced from performing the sample-based controls on the digital content tag.

12. The method of claim 11, wherein the replicated or emulated user interactions include hovering or clicking interactions.

13. A computer system comprising:
a computer memory to store instructions;
one or more processors configured to execute the stored instructions and perform operations comprising:
receiving, at a first compute device, a plurality of digital content tags, each of the plurality of digital content tags being configured to execute in client environments to load a corresponding third-party digital content;
for each digital content tag of the plurality of digital content tags, executing a security compliance assessment on the digital content tag based at least in part on a set of parameters associated with a publisher, including performing sample-based controls on the digital content tag by replicating or emulating one or more client compute environments;
wherein for at least a first digital content tag of the plurality of digital content tags, executing the security compliance assessment includes determining, for at least a first digital content tag of the plurality of digital content tags, (i) a security or compliance issue associated with the first digital content tag, and (ii) an identifier that uniquely identifies the corresponding third-party digital content of the first digital content tag that is responsible for the determined issue; and
wherein for at least the first digital content tag, the method further comprises:
generating a blocking rule to match to the identifier of the corresponding third-party digital content of the first digital content tag;
generating a blocking-enabled tag that is logically related to the blocking rule; and
providing the blocking-enabled tag to a client compute device in connection with the client compute device rendering web-based content of the publisher, the blocking-enabled tag being configured to execute on the client compute device to prevent, based on the blocking rule, the client compute device from being served the corresponding third-party digital content of the first digital content tag.

14. The computer system of claim 13, wherein the operations further comprise:
determining the identifier of the corresponding third-party digital content using network log information obtained from executing the security compliance assessment.

15. The computer system of claim 14, wherein the identifier is based at least in part on a fragment that uniquely identifies the corresponding third-party digital content.

16. The computer system of claim 15, wherein the fragment corresponds to a script or code for the corresponding third-party digital content.

17. The computer system of claim 15, wherein the fragment corresponds to a caller argument used with execution of the first digital content tag.

18. The computer system of claim 15, wherein the fragment corresponds to an HTTP response to execution of the first digital content tag.

19. The computer system of claim 13, wherein the blocking-enabled tag is configured to cause the client compute device to request a second third-party digital content in place of the corresponding third-party digital content.

20. The computer system of claim 13, wherein generating the blocking rule is based at least in part on a set of policies of the publisher.

21. The computer system of claim 13, wherein the first digital content tag includes script code.

22. The computer system of claim 21, wherein executing the security compliance assessment on the digital content tag includes determining information on an execution flow of the script code.

23. The computer system of claim 22, wherein determining the security or compliance issue is based on analyzing the information produced from performing the sample-based controls on the digital content tag.

24. The computer system of claim 23, wherein the replicated or emulated user interactions include hovering or clicking interactions.
